(19) United States
(12) Patent Application Publication
(10) Pub. No.: US 2026/0300079 A1
(43) Pub. Date: Oct. 1, 2026

(54) LOG PROCESSING PIPELINE FOR ANOMALY DETECTION AND REMEDIATION

(71) Applicant: Dell Products L.P., Round Rock, TX (US)

(72) Inventors: WENJIN LIU, Cary, NC (US); ROBERT DUNCAN HARPER, Ipswich (GB); ZACHARY W. ARNOLD, Royal Oak, MI (US); EDWARD HENRY, Jurupa Valley, CA (US); MICHAEL BARNES, Doylestown, PA (US)

(21) Appl. No.: 19/094,616

(22) Filed: Mar. 28, 2025

(51) Int. Cl. G06F 11/07

(52) U.S. Cl. CPC G06F 11/0793; G06F 11/0709; G06F 11/079

(57) ABSTRACT

Methods and systems for managing operation of a distributed system are disclosed. The operation may be managed by generating, using a log processing pipeline, remediation plans to resolve anomalies based on log entries and/or contextual information related to the log entries. The anomalies may be identified by identifying deviations in sequences of log elements of log entries of a log in the log processing pipeline. The contextual information of the anomalies may be obtained by performing a retrieval augmented generation process using descriptions of the anomalies. The remediations plans may be generated, using a trained generative machine learning model, the descriptions, and/or the contextual information. Further, performance of the remediation plans may be facilitated by a stakeholder of the distributed system and/or the trained generative machine learning model.

### FIELD

Embodiments disclosed herein relate generally to managing operation of a distributed system. More particularly, embodiments disclosed herein relate to generating, using a log processing pipeline, remediation plans to resolve anomalies based on log entries and contextual information related to the log entries.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2B show data flow diagrams illustrating operation of the distributed system in accordance with an embodiment.

FIGS. 3A-3B show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a distributed system. The operation may be managed by generating, using a log processing pipeline, remediation plans to resolve anomalies based on log entries and/or contextual information related to the log entries.

To generate the remediation plan, an occurrence of a diagnostic event may be identified. Based on the occurrence of the diagnostic event, a portion of log entries may be collected that are related to the occurrence. Log elements may be extracted from the portion of the log entries. The log elements may then be ingested in a first trained machine learning model to identify at least one anomaly in the log elements. The first trained machine learning model may include transformer-based models that are adapted to identify deviations in sequences of log elements.

The at least one anomaly may be ingested by a first trained generative machine learn model to generate a description. The description may include a summary and/or classification of the at least one anomaly. A retrieval augmented generation process may be performed, using the description and a portion of knowledge base, to retrieve contextual information for the at least one anomaly. The description and/or the contextual information may be ingested by a second trained generative machine learning model to generate the remediation plan.

Performance of the remediation plan may be facilitated by (i) a stakeholder (e.g., a user, an administrator, a customer, and/or any other stakeholder) and/or (ii) the second trained generative machine learning model during an automated management process to resolve the at least one anomaly. The second trained generative machine learning model may be adapted to generate and/or facilitate the performance of the remediation plan.

In an embodiment, a method for managing operation of a distributed system is disclosed. The method may include: (i) identifying an occurrence of a diagnostic event for a data processing system of the distributed system, (ii) discriminating, based on the occurrence of the diagnostic event and using the occurrence of the diagnostic event, a portion of log entries of a log of the operation of the data processing system, (iii) generating, using the portion of the log entries, a description of an event that impacted the data processing system based on the portion of the log entries, (iv) discriminating, using the description of the event, the portion of a knowledge base, (v) generating, using the portion of the knowledge base and the description, a remediation plan for the data processing system, and (vi) performing the remediation plan to facilitate continued provisioning of computer implemented services using the data processing system.

The diagnostic event may include at least one indication of at least one anomaly in the operation of the data processing system.

The description of the event may include a summary of a portion of the operation of the data processing system associated with the at least one anomaly.

The portion of the log entries may include at least one selected from a group consisting of: (i) a first portion of the log entries that (a) lead up to the occurrence of the diagnostic event and (b) are based on events that impacted the operation of the data processing system within a first period of a time, (ii) a second portion of the log entries that (a) correspond to the occurrence of the diagnostic event, and (b) are based on events that impacted the operation of the data processing system within a second period of the time, and (iii) a third portion of the log entries that (a) follow the occurrence of the diagnostic event, and (b) are based on events that impacted the operation of the data processing system within a third period of the time.

The portion of the log entries may be associated with at least one anomaly that is identified by performance of a relationship analysis using at least one of the first portion of the log entries, the second portion of the log entries, and the third portion of the log entries.

The relationship analysis may be performed by a first machine learning model, the first machine learning model comprising a transformer-based encoder model.

Generating the description of the event may include ingesting the portion of the log entries into a first trained generative machine learning model adapted to generate the description of the event.

Generating the remediation plan may include ingesting, in part, the portion of the knowledge base and the description into a second trained generative machine learning model adapted to generate the remediation plan.

Discriminating the portion of the knowledge base may include (i) performing, using the description of the event, a search for contextual information in a data repository of the distributed system and (ii) obtaining, based on the search, the portion of the knowledge base from the data repository.

The portion of the knowledge base may include the contextual information of the description of the event.

The log comprises a plurality of log entries, each of the plurality of the log entries comprising respective portions of information regarding the operation of the data processing system, none of the plurality of log entries being explicitly labeled with respect to the event that impacted the data processing system, and a minority of the plurality of log entries being usable to identify the event.

The event may be identified using unsupervised learning to classify the plurality of log entries with respect to anomalousness.

The occurrence of the diagnostic event may be a user requesting assistance with the data processing system, the user providing a description of an undesired condition of the data processing system, and the description of the undesired condition also being used, in part, to obtain the remediation plan.

The description of the undesired condition may be used, in part, to generate a prompt by a trained generative machine learning model.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

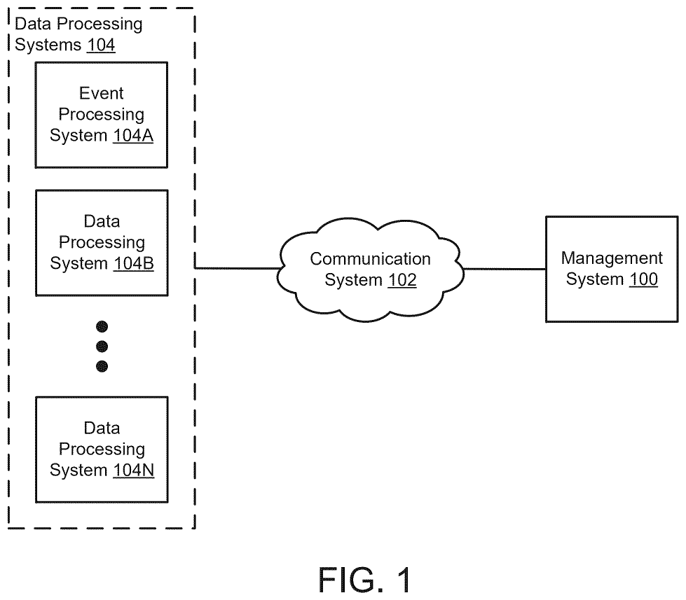

Turning to FIG. 1, a distributed system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, logs may be generated by the distributed system. The logs may include (i) application logs (e.g., the logs that include first information concerning application events, application errors, application activities, and/or any other first information concerning applications), (ii) system logs (e.g., the logs that include second information concerning system level events, system level errors, system level activities, and/or any other second information concerning the distributed system), (iii) access logs (e.g., the logs that include third information concerning user logins, access to distributed system resources, actions performed by users, and/or any other third information concerning user activities), (iv) transaction logs (e.g., the logs that include fourth information concerning transactions processed by the distributed system, such as database operations, financial transactions, network transactions, and/or any other transactions), (v) audit logs (e.g., the logs that include fifth information concerning security, such as configuration changes, administrative actions, and/or any other security-related activities of the distributed system), etc.

The distributed system may generate a large number of the logs, particularly as a scale and/or volume of activities of the distributed system increases. As a result of the large number of the logs, an identification of the information may be difficult to facilitate. Further, a log of the logs may include (i) messages, (ii) information, (iii) comments, (iv) descriptions, etc. in multiple formats and/or non-standardized formats. As a result, processing the relevant information may also be difficult to facilitate. In addition, because of (i) the large number of the logs, (ii) the multiple formats of the logs, and/or (iii) the non-standardized formats of the logs, performance of a log analysis by a stakeholder (e.g., a user, an administrator, a customer, and/or any other stakeholder) may be time-consuming. Finally, the log of the logs may include a limited scope of contextual information (e.g., (i) timestamp, (ii) severity of the log, (iii) host system information, (iv) user information, (v) thread identification, (vi) process identification, (vii) error code, (viii) relevant configuration data, and/or (ix) any other contextual information).

As a result, a determination of at least one anomalous behavior by the distributed system may be impeded by the generation of the logs. Characteristics of the logs (e.g., (i) the large number of the logs, (ii) the multiple formats of the logs, (iii) the non-standardized formats of the logs, and/or (iv) the limited scope of the contextual information of the logs) may inhibit monitoring and/or troubleshooting of the distributed system to perform the determination of the at least one anomalous behavior. Therefore, provisioning of the computer implemented services may be impacted.

In general, embodiments disclosed here relate to systems and methods for managing operation of a distributed system. The operation may be managed by (i) identifying an occurrence of a diagnostic event for a data processing system of the distributed system, (ii) discriminating, based on the occurrence of the diagnostic event and/or using the occurrence of the diagnostic event, a portion of log entries of a log of the operation of the data processing system, (iii) generating, using the portion of the log entries, a description of an event that impacted the data processing system based on the portion of the log entries, (iv) discriminating, using the description of the event, the portion of a knowledge base, (v) generating, using the portion of the knowledge base and the description, a remediation plan for the data processing system, and/or (vi) performing the remediation plan to facilitate continued provisioning of computer implemented services using the data processing system.

The occurrence of the diagnostic event for the data processing system of the distributed system may be identified by (i) receiving a request, by a stakeholder (e.g., a user, an administrator, a customer, and/or any other stakeholder) for assistance with the data processing system, wherein the stakeholder provides a description of an undesired condition of the data processing system, (ii) tracking key performance indicators (e.g., memory consumption, network latency, throughput, central processing unit (CPU) usage, and/or any other key performance indicator), (iii) receiving automated alerts that identify (a) predefined thresholds (i.e. of CPU usage, memory consumption, response times, error rates, and/or of any other metric and/or rate of the any other metric of the distributed system) that have been exceeded and/or (b) patterns (e.g., sudden increases in requests in a short period of time, sudden resource exhaustion, cascading failures, at least one deviation in behavior by at least one user, and/or any other pattern) in the operation of the data processing system and/or (iv) any other method to identify the occurrence.

The diagnostic event may include at least one indication of at least one anomaly of the data processing system. The at least one anomaly may include (i) high error rates by at least one application and/or component, (ii) incorrect and/or unexpected changes in configurations, (iii) unexpected outages, (iv) inconsistencies and/or discrepancies in processed data and/or stored data, (v) unauthorized data access, etc. of the data processing system.

The portion of the log entries of the log of the operation of the data processing system may be discriminated based on the occurrence of the diagnostic event and/or using the occurrence of the diagnostic event. The portion of the log entries may include (i) a first portion of the log entries that (a) lead up to the occurrence of the diagnostic event and/or (b) are based on events that impacted the operation of the data processing system within a first period of a time; (ii) a second portion of the log entries that (a) correspond to the occurrence of the diagnostic event and/or (b) are based on events that impacted the operation of the data processing system within a second period of the time, and/or (iii) a third portion of the log entries that (a) follow the occurrence of the diagnostic event and/or (b) are based on events that impacted the operation of the data processing system within a third period of the time.

The portion of the log entries may be discriminated by (i) parsing the log entries to generate log elements of the log entries, (ii) ingesting, by a first machine learning model, the log elements to perform a relationship analysis, and/or (iii) identifying, by the relationship analysis of the log elements, the at least one anomaly of the data processing system. The portion of the log entries may be parsed using, for example, a general parser and/or a specific parser.

The general parser may (i) ingest log entries with different formats, (ii) compare a first portion of log entries to a second portion of log entries to (a) identify patterns, (b) trace an operation, (c) identify usage behavior, and/or (d) perform any other monitoring of a system health of the data processing system, and/or (iii) generate the log elements. The log elements may include any log element of the log entries (e.g., timestamps, user identifications, messages, error codes, configuration data, and/or any other element), The specific parser may (i) ingest log entries with pre-defined formats and/or (ii) operate similarly to the general parser.

The first machine learning model may include transformer-based models, such as (i) LogBERT (i.e., Log anomaly detection based on Bidirectional Encoder Representations from Transformers (BERT)), (ii) LogCBTL (log anomaly detection using Convolution Temporal, BiLSTM (Bidirectional Long Short-Term Memory), and BERT Language Models), (iii) LogLR (Log anomaly detection based on Logical Reasoning), and/or (iv) any other transformer-based model. The first machine learning model may identify the at least one anomaly by (i) performing an analysis of contextual relationships between log elements and/or (ii) detecting deviations from patterns of sequences of the log elements to identify the at least one anomaly.

Once the at least one anomaly has been identified, a description of an event may be generated, using the portion of the log entries, that impacted the data processing system based on the portion of the log entries. The event may include the occurrence of the at least one anomaly that has affected the operation of the data processing system. The description of the event may be generated using a first trained generative machine learning model (e.g., a first large language model, a first small language model, and/or any other first generative trained machine learning model). The description of the event may include a summary of the at least one anomaly of the data processing system. The summary may include (i) a classification of the at least one anomaly, (ii) a list of affected components of the data processing system, (iii) a severity level (e.g., low, medium, high, critical, etc.), (iv) frequency of the occurrence, etc.

The portion of a knowledge base may be discriminated using the description of the event by (i) obtaining contextual information from the portion of the knowledge base and/or (ii) including the contextual information with the description of the event. The contextual information may include (i) a configuration of at least one component of the data processing system before, during, and/or after the event, (ii) user actions before, during, and/or after the event, (iii) a status of at least one dependency of the data processing system, (iv) historical data of previous occurrences of the event and/or any of similar events to the event, (v) system health metrics of any component of the data processing system before, during, and/or after the event, etc.

The knowledge base may be stored on at least one data repository of the data processing system. The knowledge base may include (i) configurations of the at least one component of the data processing system, (ii) the user actions, (iii) historical status updates of the at least one dependency of the data processing system, (iv) the historical data of the previous occurrences of the events, including the event and/or the similar events, (v) the system health metrics of the any component of the data processing system, (vi) documentation (e.g., frequency asked questions, solutions to historical events, and/or any other documentation), etc.

The remediation plan for the data processing system may be generated using the portion of the knowledge base and/or the description. The remediation plan may be generated by (i) ingesting, by a second trained generative machine learning model (e.g., a second large language model, a second small language model, and/or any other second generative trained machine learning model), the portion of the knowledge base and/or the description and/or (ii) performing an analysis of the portion of the knowledge base and/or the description to resolve the at least one anomaly. The remediation plan may include at least one task to perform on the data processing system that uses any portion of the description and/or the contextual information to resolve the at least one anomaly and/or to prevent a reoccurrence of the at least one anomaly.

The remediation plan may be performed to facilitate continued provisioning of computer implemented services using the data processing system. Performance of the remediation plan may include (i) detecting and/or isolating the at least one anomaly, (ii) performing the at least one task on the data processing system to resolve the at least one anomaly, (iii) monitoring at least one component of the data processing system to ensure the at least one anomaly has been resolved, (iv) verifying an effectiveness of the remediation plan to resolve the at least one anomaly, and/or (v) documenting performance of the remediation plan, including documenting (a) an identification of the at least one anomaly, (b) the at least one task, (c) at least one outcome of the at least one task, and/or (d) any review of (1) the remediation plan, (2) the at least one component of the data processing system, (3) configuration of the data processing system, (4) user activity, etc. to identify at least one preventative measure for the reoccurrence of the at least one anomaly.

To provide the above noted functionality, the system may include management system 100 and/or data processing systems 104. Each of these components is discussed below.

Data processing systems 104 may include event processing system 104A and/or any number of data processing system 104B-104N. Event processing system 104A may receive a notification by (i) a stakeholder (e.g., a user, an administrator, a customer, and/or any other stakeholder), (ii) an automated system, and/or (iii) any other entity of the distributed system. The notification may an occurrence of a diagnostic event. The diagnostic event may include at least one indication of at least one anomaly in an operation of any number of data processing system 104B-104N.

Event processing system 104A may transmit a portion of log entries to the any number of data processing systems 104B-104N and/or management system 100. The portion of the log entries may include (i) a first portion of the log entries that (a) lead up to the occurrence of the diagnostic event and/or (b) are based on events that impacted the operation of the data processing system within a first period of a time; (ii) a second portion of the log entries that (a) correspond to the occurrence of the diagnostic event and/or (b) are based on events that impacted the operation of the data processing system within a second period of the time, and/or (iii) a third portion of the log entries that (a) follow the occurrence of the diagnostic event and/or (b) are based on events that impacted the operation of the data processing system within a third period of the time.

The any number of data processing systems 104B-104N and/or management system 100 may discriminate the portion of the log entries. The any number of data processing systems 104B-104N and/or management system 100 may include parsers (e.g., general parsers, specific parser, and/or any parsing application) that extract log elements of the portion of the log entries. The any number of data processing systems 104B-104N and/or management system 100 may also a first trained machine learning model (e.g., transformer-based models) used to identify, using the log elements, the at least one anomaly of the any number of data processing systems 104B-104N.

The any number of data processing systems 104B-104N and/or management system 100 may include a first trained generative machine learning model (e.g., a first large language model, a first small language model, and/or any other first generative trained machine learning model) that is adapted to generate a description of an event of the any number of data processing systems 104B-104N. The event may include the occurrence of the at least one anomaly that has affected the operation of the any number of data processing systems 104B-104N.

The any number of data processing systems 104B-104N and/or management system 100 may include at least one data repository on which a knowledge based is stored. The knowledge base may include (i) configurations of the at least one component of the data processing system, (ii) the user actions, (iii) historical status updates of the at least one dependency of the data processing system, (iv) the historical data of the previous occurrences of the events, including the event and/or the similar events, (v) the system health metrics of the any component of the data processing system, (vi) documentation (e.g., frequency asked questions, solutions to historical events, and/or any other documentation), etc.

The any number of data processing systems 104B-104N and/or management system 100 may include a second trained generative machine learning model (e.g., a second large language model, a second small language model, and/or any other second generative trained machine learning model) that is adapted to generate a remediation plan, using a portion of the knowledge base and/or the description. The remediation plan may be transmitted to the stakeholder and/or the second trained generative machine learning model to perform at least one task of the remediation plan. The at least one task may use contextual information, obtained from the knowledge base, to resolve the at least one anomaly and/or to prevent a reoccurrence of the at least one anomaly.

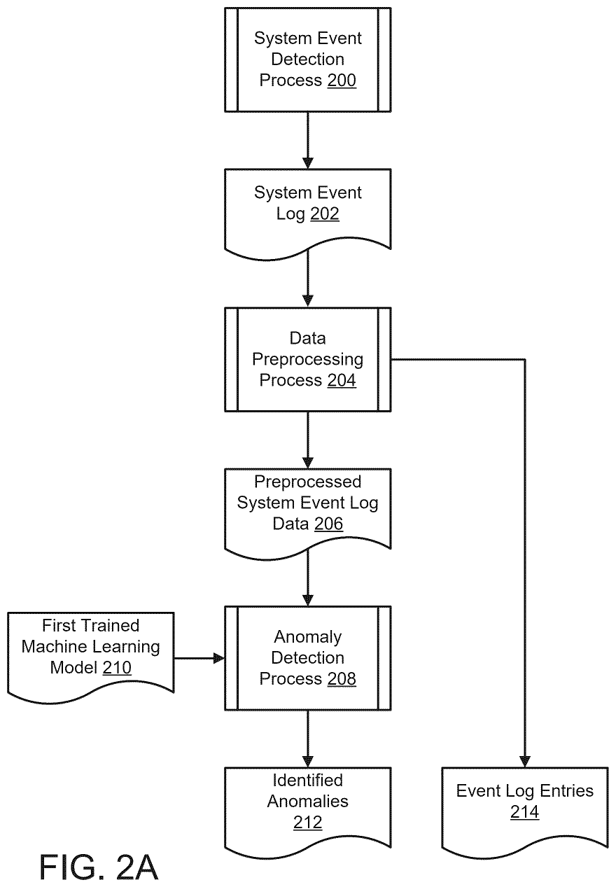

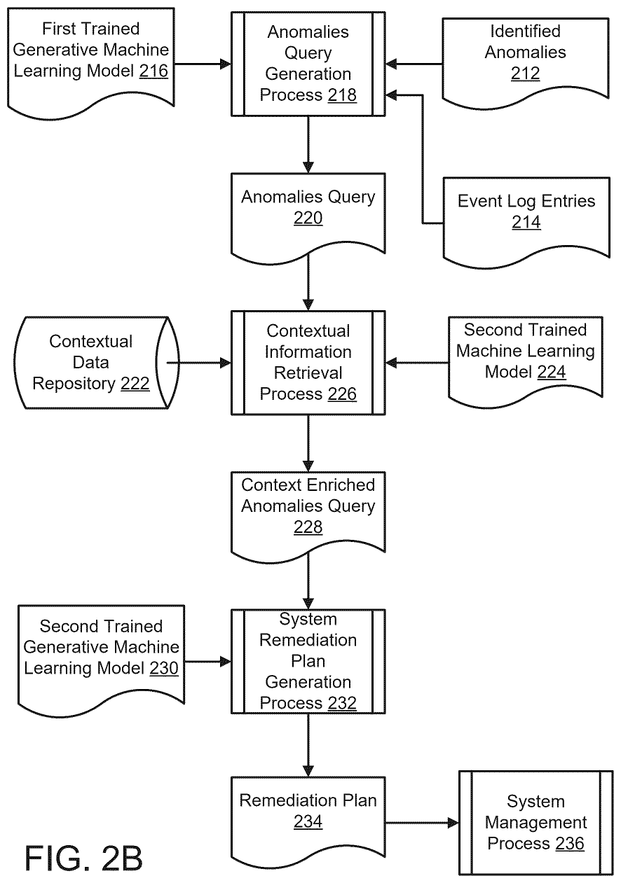

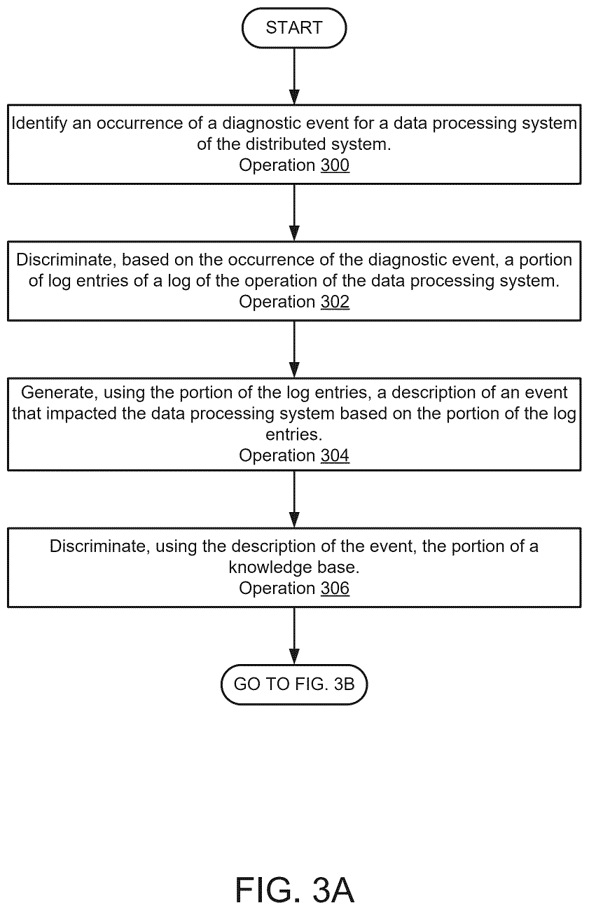

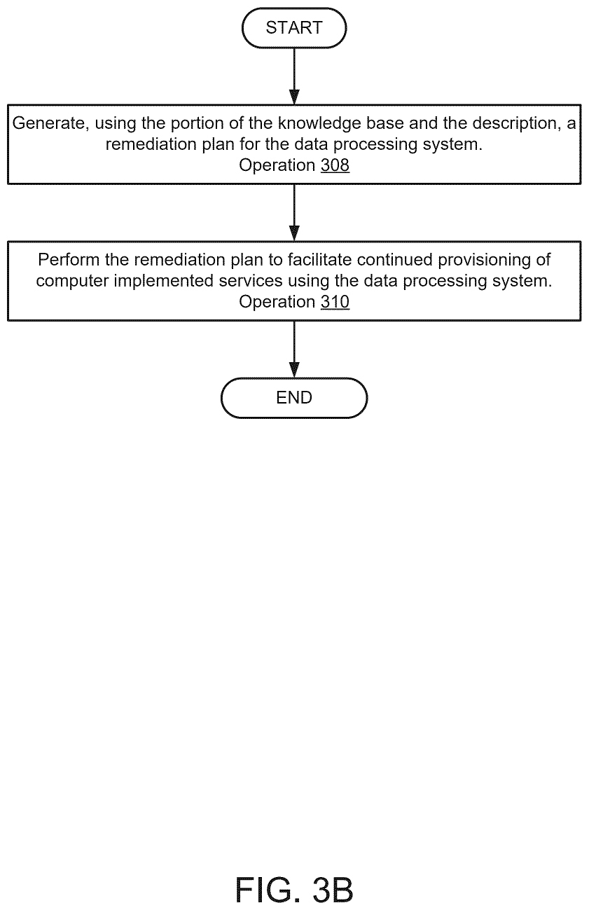

While providing their functionality, any of management system 100 and data processing systems 104 may perform all, or a portion, of the flows and methods shown in FIGS. 2A-3B.

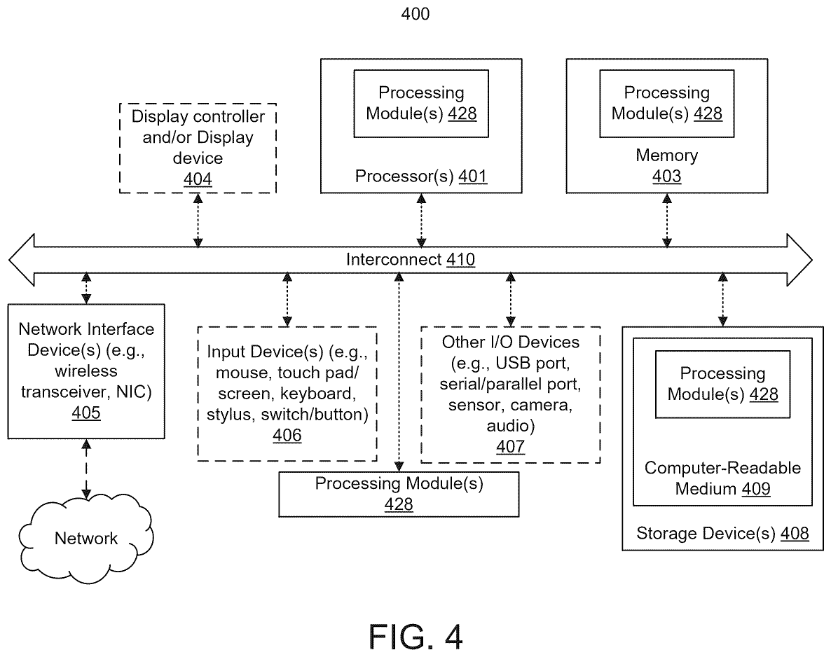

Any of (and/or components thereof) management system 100 and data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 202, 206, etc.) is used to represent data structures, a second set of shapes (e.g., 200, 204, etc.) is used to represent processes performed using and/or that generate data, and a third set of shapes (e.g., 232, etc.) is used to represent large scale data structures such as databases.

Turning to FIG. 2A, a first data flow diagram in accordance with an embodiment is shown. The first data flow diagram may illustrate data used in and data processing performed in identifying at least one anomaly of a data processing system.

To identify the at least one anomaly, a system event detection process (e.g., 200) may be performed. During the system event detection process (e.g., 200), a system log event (e.g., 202) may be generated. The system log event (e.g., 202) may be generated first by identifying an occurrence of a diagnostic event. The occurrence of the diagnostic event may be identified by (i) receiving a request, by a stakeholder (e.g., a user, an administrator, a customer, and/or any other stakeholder) for assistance with the data processing system, wherein the stakeholder provides a description of an undesired condition of the data processing system, (ii) tracking key performance indicators (e.g., memory consumption, network latency, throughput, central processing unit (CPU) usage, and/or any other key performance indicator), (iii) receiving automated alerts that identify (a) predefined thresholds (i.e. of CPU usage, memory consumption, response times, error rates, and/or of any other metric and/or rate of the any other metric of the distributed system) that have been exceeded and/or (b) patterns (e.g., sudden increases in requests in a short period of time, sudden resource exhaustion, cascading failures, at least one deviation in behavior by at least one user, and/or any other pattern) in the operation of the data processing system and/or (iv) any other method to identify the occurrence.

The diagnostic event may include at least one indication of at least one anomaly of the data processing system. The at least one anomaly may include (i) high error rates by at least one application and/or component, (ii) incorrect and/or unexpected changes in configurations, (iii) unexpected outages, (iv) inconsistencies and/or discrepancies in processed data and/or stored data, (v) unauthorized data access, etc. of the data processing system.

Once the occurrence has been identified, the system log event (e.g., 202) may be generated by (i) collecting information about the occurrence and/or (ii) documenting the information in system log event (e.g., 202). A format of the system log event (e.g., 202) may include a first data format, such as a text format (e.g., plain text file, comma separated file (CSV), etc.), a hierarchical data format (e.g., extensible markup language, JavaScript Object Notation file (JSON), etc.), (iii) a binary data format (e.g., a general binary format, an executable format, etc.), (iv) a database format (e.g., a structured query language (SQL) format, a Not Only SQL (NoSQL) format, etc.), and/or (v) any other data format. Documentation of the system log event (e.g., 202) may include log entries associated with the occurrence. The log entries may include (i) a first portion of the log entries that (a) lead up to the occurrence of the diagnostic event and/or (b) are based on events that impacted the operation of the data processing system within a first period of a time; (ii) a second portion of the log entries that (a) correspond to the occurrence of the diagnostic event and/or (b) are based on events that impacted the operation of the data processing system within a second period of the time, and/or (iii) a third portion of the log entries that (a) follow the occurrence of the diagnostic event and/or (b) are based on events that impacted the operation of the data processing system within a third period of the time.

Once the system log event (e.g., 202) has been generated, a data preprocessing process (e.g., 204) may be performed. During the data preprocessing process (e.g., 204), the system event log (e.g., 202) may be parsed to generate preprocessed system event log data (e.g., 206). The system event log (e.g., 202) may be parsed by (i) ingesting, by a parser, the system event log data (e.g., 202) and/or (ii) extracting, using the parser, the log elements of the system event log data (e.g., 202) as the preprocessed system event log data (e.g., 206). The portion of the log entries may be parsed using, for example, a general parser and/or a specific parser. The general parser may (i) ingest log entries with different formats, (ii) compare a first portion of log entries to a second portion of log entries to (a) identify patterns, (b) trace an operation, (c) identify usage behavior, and/or (d) perform any other monitoring of a system health of the data processing system, and/or (iii) generate the log elements. The specific parser may (i) ingest log entries with pre-defined formats and/or (ii) operate similarly to the general parser. The different formats and/or the pre-defined formats may be similar to and/or different from the first data format.

The preprocessed system event log data (e.g., 206) may include the log elements that are obtained from the system event log (e.g., 202). The log elements may include any element of the portion of the log entries (e.g., timestamps, user identifications, messages, error codes, configuration data, and/or any other element). The preprocessed system event log data (e.g., 206) may further include (i) correlation identifications (e.g., identifications that link any sequence of the portion of the log entries), (ii) internet protocol addresses (e.g., an origination point of the portion of the log entries), (iii) geolocations (e.g., physical locations associated with the portion of the log entries), (iv) categories (e.g., classifications of the portion of the log entries), and/or (v) any other additional data used to organize the portion of the log entries.

In addition, event log entries (e.g., 212) may be obtained from the data preprocessing process (e.g., 204). The event log entries (e.g., 212) may be obtained by extracting any sub-portion of the portion of the log entries from the system log event (e.g., 202). The any sub-portion of the portion of the log entries may include any of (i) the first portion, (ii) the second portion, and/or (iii) the third portion of the log entries. The sub-portion may be not directly associated with the occurrence of the diagnostic event. The sub-portion may be not directly associated with the occurrence if (i) a timestamp of the log entry is too long before and/or after the occurrence, (ii) the log entry does not include any keywords associated with the occurrence, (iii) the log entry does not match any identified patterns, (iv) the log entry is not associated with a user involved with the occurrence, (v) the log entry includes an error code and/or process identification that is unrelated to the occurrence, (iv) any other element of the log entry is determined to be loosely associated with and/or unrelated to the occurrence.

Once the preprocessed system event log data (e.g., 206) has been generated, an anomaly detection process (e.g., 208) may be performed to obtain identified anomalies (e.g., 212). During the anomaly detection process (e.g., 208), a first trained machine learning model (e.g., 210) may ingest the preprocessed system event log data (e.g., 206) to generate identified anomalies (e.g., 212).

The first machine learning model (e.g., 210) may include transformer-based models, such as (i) LogBERT (i.e., Log anomaly detection based on Bidirectional Encoder Representations from Transformers (BERT)), (ii) LogCBTL (log anomaly detection using Convolution Temporal, BiLSTM (Bidirectional Long Short-Term Memory), and BERT Language Models), (iii) LogLR (Log anomaly detection based on Logical Reasoning), and/or (iv) any other transformer-based model.

The first machine learning model may generate identified anomalies (e.g., 212) by (i) performing an analysis of contextual relationships of the preprocessed system event log data (e.g., 206) and/or (ii) detecting deviations from patterns of the sequences of the preprocessed system event log data (e.g., 206) to identify at least one anomaly of the identified anomalies (e.g., 212).

To perform the analysis of the contextual relationships, log elements of the preprocessed system event log data (e.g., 206) may be converted to embeddings (e.g., vectors in high-dimensional space and/or any other numerical representation). Contextual embeddings may be generated, using the embeddings, to quantify relationships between, for example, a first embedding and other embeddings. The contextual embeddings may include attention weights, which include probabilities that quantify a magnitude of association between the first embedding and/or the other embeddings.

To detect the deviations from the patterns of the sequences of the preprocessed system event log data (e.g., 206), the attention weights of the contextual embeddings may be used to weigh an importance of a first contextual embedding to a sequence of contextual embeddings. In training of the first machine learning model, the first machine learning model may be adapted to identify the patterns of the sequences from the attention weights that are generated from training datasets. The training datasets may include pluralities of historical log entries. Based on the training, if an attention weight and/or the first contextual embedding of the sequence of the contextual embeddings differs from learned patterns, then a deviation in the sequence may be detected. The deviation may include the at least one anomaly of the identified anomalies (e.g., 212).

The identified anomalies (e.g., 212) may include (i) high error rates by at least one application and/or component, (ii) incorrect and/or unexpected changes in configurations, (iii) unexpected outages, (iv) inconsistencies and/or discrepancies in processed data and/or stored data, (v) unauthorized data access, etc. of the data processing system.

Thus, via the first data flow diagram illustrated in FIG. 2A, a system in accordance with an embodiment may identify the at least one anomaly of the data processing system. Consequently, the data processing system (e.g., 104B-104N) may be more likely to be able to provide desired computer implemented services by using context of log entries to identify the deviations in an operation of the data processing system (e.g., 104B-104N).

Turning to FIG. 2B, a second data flow diagram in accordance with an embodiment is shown. The first data flow diagram may illustrate data used in and data processing performed in using a remediation plan to resolve at least one anomaly of the data processing system (e.g., 104B-104N).

To use the remediation plan to resolve the at least one anomaly, an anomalies query generation process (e.g., 218) may be performed. During the anomalies query generation process (e.g., 218), a first trained generative machine learning model (e.g., 216) may ingest identified anomalies (e.g., 212) and/or event log entries (e.g., 214) to generate an anomalies query (e.g., 220). The identified anomalies (e.g., 212) and/or the event log entries (e.g., 214) are described in the description of FIG. 2A.

The first trained generative machine learning model (e.g., 216) may include a first large language model, a first small language model, and/or any other first trained generative machine learning model (e.g., 216). During the anomaly query generation process (e.g., 218), the first trained generative machine learning model (e.g., 216) may generate the anomalies query (e.g., 220) by populating a template with the identified anomalies (e.g., 212) and/or the event log entries (e.g., 214). The event may include the occurrence of the at least one anomaly that has affected the operation of the data processing system.

The anomalies query (e.g., 220) may include the description of the event. The description of the event may include a summary of the at least one anomaly of the identified anomalies (e.g., 212). The summary may include (i) a classification of the at least one anomaly, (ii) a list of affected components of the data processing system, (iii) a severity level (e.g., low, medium, high, critical, etc.), (iv) frequency of the occurrence, etc. The summary may further include log entries of the event log entries (e.g., 214) that are associated with the at least one anomaly of the identified anomalies (e.g., 212).

Once the anomalies query (e.g., 220) has been generated, a contextual information retrieval process (e.g., 226) may be performed. During the contextual information retrieval process (e.g., 226), the anomalies query (e.g., 220), a second trained machine learning model (e.g., 224), and/or a portion of a knowledge base (e.g., a contextual data repository (e.g., 222)), may be used to generate a context enriched anomalies query (e.g., 228).

The second trained machine learning model (e.g., 224) may include (i) a word embeddings model (e.g., Word2Vec, GloVe, FastText, etc.), (ii) a sentence embedding model (e.g., Universal Sentence Encoder, Sentence-BERT, etc.), (iii) a contextual embedding model (e.g., BERT, Generative Pre-trained Transformer (GPT), etc.), (iv) a document embedding model (e.g., Doc2Vec, text-embedding-ada-002 by OpenAI, text-embedding-gecko by Google, etc.), etc.

The knowledge base (e.g., the contextual data repository (e.g., 222)) may include (i) configurations of the at least one component of the data processing system, (ii) historical user actions, (iii) historical status updates of the at least one dependency of the data processing system, (iv) historical data of the previous occurrences of events, including the event and/or similar events, (v) historical system health metrics of the any component of the data processing system, (vi) documentation (e.g., frequency asked questions, solutions to the previous occurrences of the events, and/or any other documentation), etc.

During the contextual information retrieval process (e.g., 226), a portion of the knowledge base (e.g., the contextual data repository (e.g., 222)) may be discriminated using the description of the event by (i) obtaining contextual information of the description from the portion of the knowledge base and/or (ii) including the contextual information with the description of the event. The contextual information may include (i) a configuration of at least one component of the data processing system before, during, and/or after the event, (ii) user actions before, during, and/or after the event, (iii) a status of at least one dependency of the data processing system, (iv) historical data of the previous occurrences of the event and/or any of the similar events, (v) system health metrics of any component of the data processing system before, during, and/or after the event, etc.

To obtain the contextual information, a search may be performed using keywords and/or the portion of the anomalies query (e.g., 220). Through the search, relevant documentation of the anomalies query (e.g., 220) may be obtained. The relevant documentation may be ingested by the second trained machine learning model (e.g., 224) to generate first embeddings (e.g., vectors in high-dimensional space and/or any other numerical representation). The first embeddings may be (i) stored with second embeddings of an embedding repository (the contextual data repository (e.g., 222) and/or any other repository of the distributed system) in any portion of the distributed system and/or (ii) indexed, with the second embeddings, in the embedding repository to enable fast lookup for future queries. Further, any first portion of the first embeddings and/or any second portion of the second embeddings may be ingested in a similarity search to identify third embeddings of the contextual information. The third embeddings may include any sub-portion of the first portion and/or the second portion.

The documentation of knowledge base (e.g., the contextual data repository (e.g., 222)) may include unique identifiers. When any documentation is converted into any embeddings (e.g., first embedding, second embedding, third embedding, etc.), the unique identifiers may be transmitted to the embedding repository. Once the third embeddings are identified, the unique identifiers may be used to identify the contextual information associated with the third embeddings from the knowledge base (e.g., the contextual data repository (e.g., 222)). The contextual information may be included in the anomalies query (e.g., 220) to generate the context enriched anomalies query (e.g., 228).

The context enriched anomalies query (e.g., 228) may include the anomalies query (e.g., 220). The context enriched anomalies query (e.g., 228) may further include (i) a configuration of at least one component of the data processing system before, during, and/or after the event, (ii) user actions before, during, and/or after the event, (iii) a status of at least one dependency of the data processing system, (iv) the historical data of previous occurrences of the event and/or any similar events, (v) the system health metrics of any component of the data processing system before, during, and/or after the event, etc.

Once the context enriched anomalies query (e.g., 228) has been obtained, a system remediation plan generation process (e.g., 232) may be performed. During the system remediation plan generation process (e.g., 232), the context enriched anomalies query (e.g., 228) may be ingested by a second trained generative machine learning model (e.g., 230). The second trained generative machine learning model (e.g., 216) may include a second large language model, a second small language model, and/or any other second generative trained machine learning model.

The second trained generative machine learning model (e.g., 230), upon the ingestion, may perform an analysis of (i) a summary of the at least one anomaly, (ii) the log entries associated with the at least one anomaly, (iii) the contextual information of the context enriched anomalies query (e.g., 228), and/or (iv) any other component of the context enriched anomalies query (e.g., 228) to generate a remediation plan (e.g., 234). The second trained generative machine learning model may be adapted to generate and/or facilitate performance of the remediation plan (e.g., 234)

The remediation plan (e.g., 234) may include at least one task that leverages any portion of the description and/or the contextual information to resolve the at least one anomaly and/or to prevent a reoccurrence of the at least one anomaly.

Once the remediation plan (e.g., 234) has been generated, a system management process (e.g., 236) may be performed. During the system management process (e.g., 236), the at least one task of the remediation plan (e.g., 234) may be performed. The at least one task may be performed by (i) a stakeholder (e.g., a user, an administrator, a customer, and/or any other stakeholder) and/or (ii) the second trained generative machine learning model during an automated management process of the data processing system.

Performance of the remediation plan (e.g., 234) may include (i) detecting and/or isolating the at least one anomaly, (ii) performing the at least one task on the data processing system to resolve the at least one anomaly, (iii) monitoring at least one component of the data processing system to ensure the at least one anomaly has been resolved, (iv) verifying an effectiveness of the remediation plan to resolve the at least one anomaly, and/or (v) documenting performance of the remediation plan, including documenting (a) an identification of the at least one anomaly, (b) the at least one task, (c) at least one outcome of the at least one task, and/or (d) any review of (1) the remediation plan, (2) the at least one component of the data processing system, (3) configuration of the data processing system, (4) user activity, etc. to identify at least one preventative measure for the reoccurrence of the at least one anomaly.

Thus, via the second data flow diagram illustrated in FIG. 2B, a system in accordance with an embodiment may use the remediation plan (e.g., 234) to resolve the at least one anomaly of the data processing system (e.g., 104B-104N). Consequently, the data processing system (e.g., 104B-104N) may be more likely to be able to provide desired computer implemented services by (i) performing corrective actions of the remediation plan (e.g., 234) that resolve the at least one anomaly, (ii) preventing likely future occurrences of the at least one anomaly to ensure a likelihood of normal operation by the data processing system (e.g., 104B-104N).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to managing operation of a distributed system. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing the operation of the distributed system in accordance with an embodiment is shown. The method may be performed, for example, by any of the components of the system of FIG. 1, and/or other components not shown therein.

At operation 300, an occurrence of a diagnostic event for a data processing system of the distributed system may be identified. The occurrence may be identified by (i) receiving a request, by a stakeholder (e.g., a user, an administrator, a customer, and/or any other stakeholder) for assistance with the data processing system, wherein the stakeholder provides a description of an undesired condition of the data processing system, (ii) tracking key performance indicators (e.g., memory consumption, network latency, throughput, central processing unit (CPU) usage, and/or any other key performance indicator), (iii) receiving automated alerts that identify (a) predefined thresholds (i.e. of CPU usage, memory consumption, response times, error rates, and/or of any other metric and/or rate of the any other metric of the distributed system) that have been exceeded and/or (b) patterns (e.g., sudden increases in requests in a short period of time, sudden resource exhaustion, cascading failures, at least one deviation in behavior by at least one user, and/or any other pattern) in the operation of the data processing system and/or (iv) any other method to identify the occurrence.

At operation 302, a portion of the log entries of a log operation of the data processing system may be discriminated based on the occurrence of the diagnostic event. The portion may be discriminated by (i) parsing the log entries to generate log elements of the log entries, (ii) ingesting, by a first machine learning model, the log elements to perform a relationship analysis, and/or (iii) identifying, by the relationship analysis of the log elements, the at least one anomaly of the data processing system.

At operation 304, a description of an event that impacted the data processing system may be generated, using the portion of the log entries, based on the portion of the log entries. The description may be generated by ingesting, by a first trained generative machine learning model (e.g., a first large language model, a first small language model, and/or any other first generative trained machine learning model), the portion of the log entries to generate the description of the event. The description of the event may include a summary of the at least one anomaly. The summary may include (i) a classification of the at least one anomaly, (ii) a list of affected components of the data processing system, (iii) a severity level (e.g., low, medium, high, critical, etc.), (iv) frequency of the occurrence, etc. The summary may further include the log entries that are associated with the at least one anomaly.

At operation 306, the portion of a knowledge base may be discriminated using the description of the event. The portion of the knowledge base may be discriminated by (i) performing, using the description of the event, a search for contextual information in a data repository of the distributed system and/or (ii) obtaining, based on the search, the portion of the knowledge base from the data repository. The search may be performed by using keywords and/or any content of the description to obtain documentation that includes content related to the description. The portion of the knowledge base may be obtained by (i) generating first embeddings of the documentation to store in a embeddings repository with second embeddings, (ii) performing a similarity search using any sub-portion of the first embeddings and/or the second embeddings to obtain third embeddings, and/or (iii) using unique identifiers of the third embeddings to retrieve the contextual information associated with the third embeddings. The contextual information may include (i) a configuration of at least one component of the data processing system before, during, and/or after the event, (ii) user actions before, during, and/or after the event, (iii) a status of at least one dependency of the data processing system, (iv) historical data of the previous occurrences of the event and/or any of the similar events, (v) system health metrics of any component of the data processing system before, during, and/or after the event, etc.

Turning to FIG. 3B, following operation 306, at operation 308, a remediation plan for the data processing system may be generated using the portion of the knowledge base and the description. The remediation plan may be generated by (i) ingesting, by a second trained generative machine learning model (e.g., a second large language model, a second small language model, and/or any other second generative trained machine learning model), the portion of the knowledge base and/or the description and/or (ii) performing an analysis of the portion of the knowledge base and/or the description of the remediation plan to resolve the at least one anomaly.

At operation 310, the remediation plan may be performed to facilitate continued provisioning of computer implemented services using the data processing system. The remediation may be performed by performing at least one task of the remediation plan. Performance of the remediation may include (i) detecting and/or isolating the at least one anomaly, (ii) performing the at least one task on the data processing system to resolve the at least one anomaly, (iii) monitoring at least one component of the data processing system to ensure the at least one anomaly has been resolved, (iv) verifying an effectiveness of the remediation plan to resolve the at least one anomaly, and/or (v) documenting performance of the remediation plan, including documenting (a) an identification of the at least one anomaly, (b) the at least one task, (c) at least one outcome of the at least one task, and/or (d) any review of (1) the remediation plan, (2) the at least one component of the data processing system, (3) configuration of the data processing system, (4) user activity, etc. to identify at least one preventative measure for the reoccurrence of the at least one anomaly.

The method may end following operation 310.

Thus, via the method shown in FIGS. 3A-3B, embodiments herein may likely improve a likelihood of managing the operation of the distributed system. By improving the likelihood of managing the operation of the distributed system, the distributed system may be more likely to provide desirable computer implemented services by, for example, identifying, based on the log entries, the at least one anomaly in the operation of the distributed system, obtaining the contextual information for the at least one anomaly, determining, based on at least the contextual information and/or an identification of the at least one anomaly, the remediation plan to resolve the at least one anomaly, etc.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system, the method comprising:
identifying an occurrence of a diagnostic event for a data processing system of the distributed system;
based on the occurrence of the diagnostic event:
discriminating, using the occurrence of the diagnostic event, a portion of log entries of a log of the operation of the data processing system;
generating, using the portion of the log entries, a description of an event that impacted the data processing system based on the portion of the log entries;
discriminating, using the description of the event, the portion of a knowledge base;
generating, using the portion of the knowledge base and the description, a remediation plan for the data processing system; and
performing the remediation plan to facilitate continued provisioning of computer implemented services using the data processing system.

2. The method of claim 1, wherein the diagnostic event comprises at least one indication of at least one anomaly in the operation of the data processing system.

3. The method of claim 2, wherein the description of the event comprises a summary of the portion of the operation of the data processing system associated with the at least one anomaly.

4. The method of claim 1, wherein the portion of the log entries comprises at least one selected from a group consisting of:
a first portion of the log entries that:
lead up to the occurrence of the diagnostic event, and
are based on events that impacted the operation of the data processing system within a first period of a time;
a second portion of the log entries that:
correspond to the occurrence of the diagnostic event, and
are based on the events that impacted the operation of the data processing system within a second period of the time; and
a third portion of the log entries that:
follow the occurrence of the diagnostic event, and
are based on the events that impacted the operation of the data processing system within a third period of the time.

5. The method of claim 4, wherein the portion of the log entries are associated with at least one anomaly that is identified by performance of a relationship analysis using at least one of the first portion of the log entries, the second portion of the log entries, and the third portion of the log entries.

6. The method of claim 5, wherein the relationship analysis be performed by a first machine learning model, the first machine learning model comprising a transformer-based encoder model.

7. The method of claim 1, wherein generating the description of the event comprises ingesting the portion of the log entries into a first trained generative machine learning model adapted to generate the description of the event.

8. The method of claim 1, wherein generating the remediation plan comprises ingesting, in part, the portion of the knowledge base and the description into a second trained generative machine learning model adapted to generate the remediation plan.

9. The method of claim 1, wherein discriminating the portion of the knowledge base comprises:
performing, using the description of the event, a search for contextual information in a data repository of the distributed system; and
obtaining, based on the search, the portion of the knowledge base from the data repository.

10. The method of claim 9, wherein the portion of the knowledge base comprises the contextual information of the description of the event.

11. The method of claim 1, wherein the log comprises a plurality of log entries, each of the plurality of the log entries comprising respective portions of information regarding the operation of the data processing system, none of the plurality of log entries being explicitly labeled with respect to the event that impacted the data processing system, and a minority of the plurality of log entries being usable to identify the event.

12. The method of claim 11, wherein the event is identified using unsupervised learning to classify the plurality of log entries with respect to anomalousness.

13. The method of claim 1, wherein the occurrence of the diagnostic event is a user requesting assistance with the data processing system, the user providing a second description of an undesired condition of the data processing system, and the second description of the undesired condition also being used, in part, to obtain the remediation plan.

14. The method of claim 13, wherein the second description of the undesired condition is used, in part, to generate a prompt by a trained generative machine learning model.

15. A non-transitory machine-readable medium having instructions stored therein, which when executed by a processor, cause the processor to perform operations for managing operation of a distributed system, the operations comprising:
identifying an occurrence of a diagnostic event for a data processing system of the distributed system;
based on the occurrence of the diagnostic event:
discriminating, using the occurrence of the diagnostic event, a portion of log entries of a log of the operation of the data processing system;
generating, using the portion of the log entries, a description of an event that impacted the data processing system based on the portion of the log entries;
discriminating, using the description of the event, the portion of a knowledge base;
generating, using the portion of the knowledge base and the description, a remediation plan for the data processing system; and
performing the remediation plan to facilitate continued provisioning of computer implemented services using the data processing system.

16. The non-transitory machine-readable medium of claim 15, wherein the diagnostic event comprises at least one indication of at least one anomaly in the operation of the data processing system.

17. The non-transitory machine-readable medium of claim 16, wherein the description of the event comprises a summary of a portion of the operation of the data processing system associated with the at least one anomaly.

18. A data processing system, comprising:
a processor; and
a memory coupled to the processor to store instructions, which when executed by the processor, cause the processor to perform operations managing operation of a distributed system, the operations comprising:
identifying an occurrence of a diagnostic event for a data processing system of the distributed system;
based on the occurrence of the diagnostic event:
discriminating, using the occurrence of the diagnostic event, a portion of log entries of a log of the operation of the data processing system;
generating, using the portion of the log entries, a description of an event that impacted the data processing system based on the portion of the log entries;
discriminating, using the description of the event, the portion of a knowledge base;
generating, using the portion of the knowledge base and the description, a remediation plan for the data processing system; and
performing the remediation plan to facilitate continued provisioning of computer implemented services using the data processing system.

19. The data processing system of claim 18, wherein the diagnostic event comprises at least one indication of at least one anomaly in the operation of the data processing system.

20. The data processing system of claim 19, wherein the description of the event comprises a summary of a portion of the operation of the data processing system associated with the at least one anomaly.
